(19) United States
(12) Patent Application Publication
(10) Pub. No.: US 2006/0284398 A1
(43) Pub. Date: Dec. 21, 2006

(54) Safety device for a trailer connector

(76) Inventor: Chun-Hsien Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/156,647

(22) Filed: Jun. 21, 2005

(51) Int. Cl. B60D 1/60

(52) U.S. Cl. 280/507

(57) ABSTRACT

A safety device for a trailer connector includes a lock base, a hook and a lock core. The lock base comprises an engaging trough and a hole therein. The hole is to receive the hook therein, and the lock core in the lock base controls movement of the hook. The hook comprises a sliding section and an engaging section. The engaging trough of the lock base is for an edge of a connector to insert therein. The engaging section of the hook tightly engages with the inner wall of a spherical recess of the connector to prevent the lock from being broken.

### BACKGROUND OF THE INVENTION

1. Field of the Invention

The present invention relates to a safety device for a trailer connector, and more particularly to a safety device coupled with a trailer connector to protect the trailer from being stolen.

2. Description of the Related Prior Art

Traveling is always a pleasure. In continental area people like to travel with their mobile home or trailer for its convenience. Most trailers are connected to the rear end of cars, pick-up or truck. A conventional connection device, as shown in FIG. 4, comprises a spherical head base A for a connector B to cover a spherical head A1 within its spherical recess B1 and is secured by a buckle C1 of a clip C to clamp a neck A2 of the spherical head A1 to prevent the connection from detachment. The spherical head A1 may be detached from the connector B so that the trailer may leave freely.

However, when the spherical head A1 is not attached to the connector B, it may be hooked to another connector and be stolen.

### SUMMARY OF THE INVENTION

It is the primary object of the present invention to provide a safety device for a trailer connector, which prevents a spherical head of a spherical head base of another person's vehicle from inserting into a spherical recess to against theft.

The present invention includes a lock base, a hook and a lock core. The lock base comprises an engaging trough and a hole therein. The hole is to receive the hook therein, and the lock core in the lock base controls movement of the hook. The hook comprises a sliding section and an engaging section. The engaging trough of the lock base is for an edge of a connector to insert therein. The engaging section of the hook tightly engages with the inner wall of a spherical recess of the connector, thereby preventing the lock from being broken.

### BRIEF DESCRIPTION OF THE DRAWINGS

FIG. 1 is an exploded view of the present invention;

FIG. 2 is a cross-sectional view of the present invention in an operating status;

FIG. 3 is a cross-sectional view of another embodiment of the present invention; and

FIG. 4 is a cross-sectional view of a prior art.

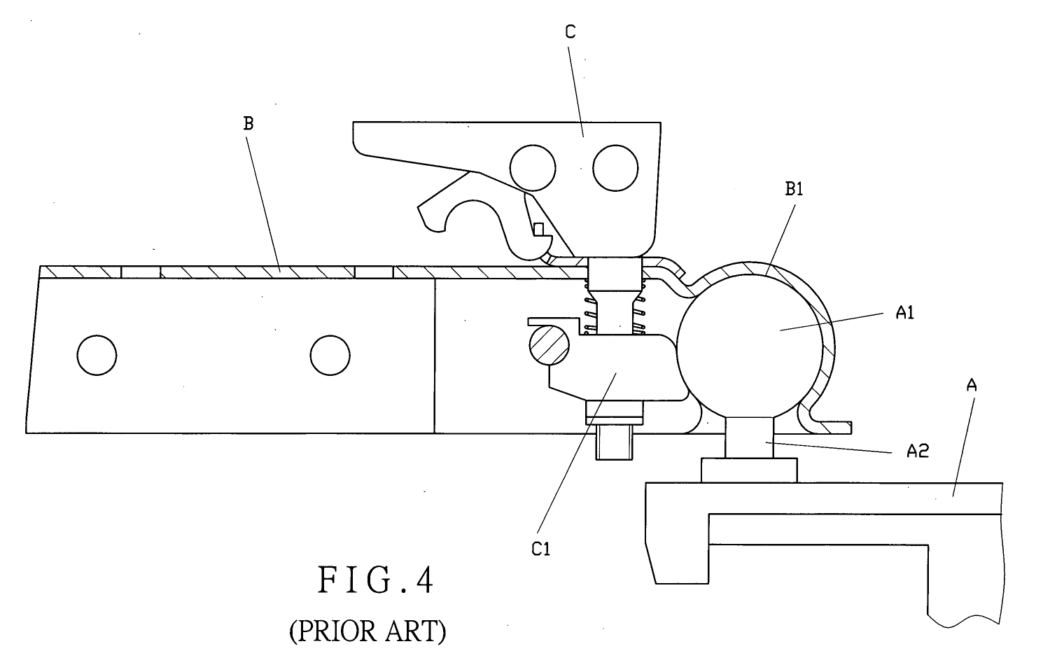

### DETAILED DESCRIPTION OF THE PREFERRED EMBODIMENT

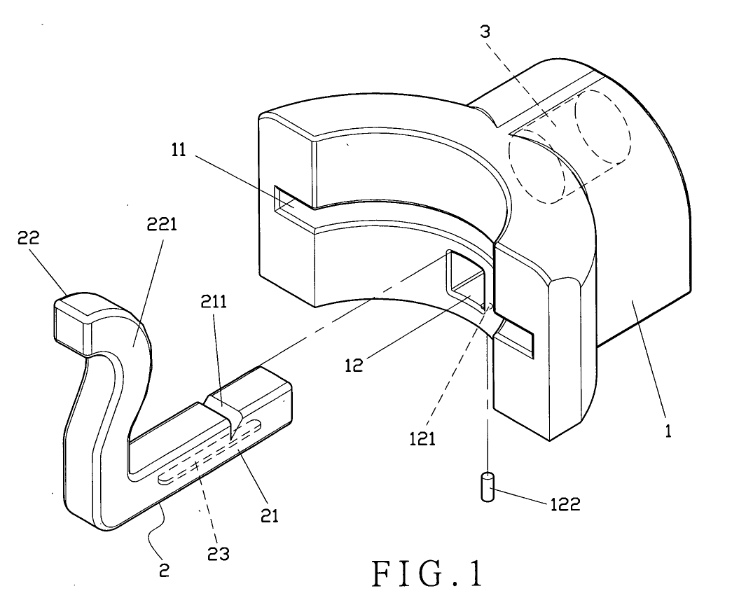

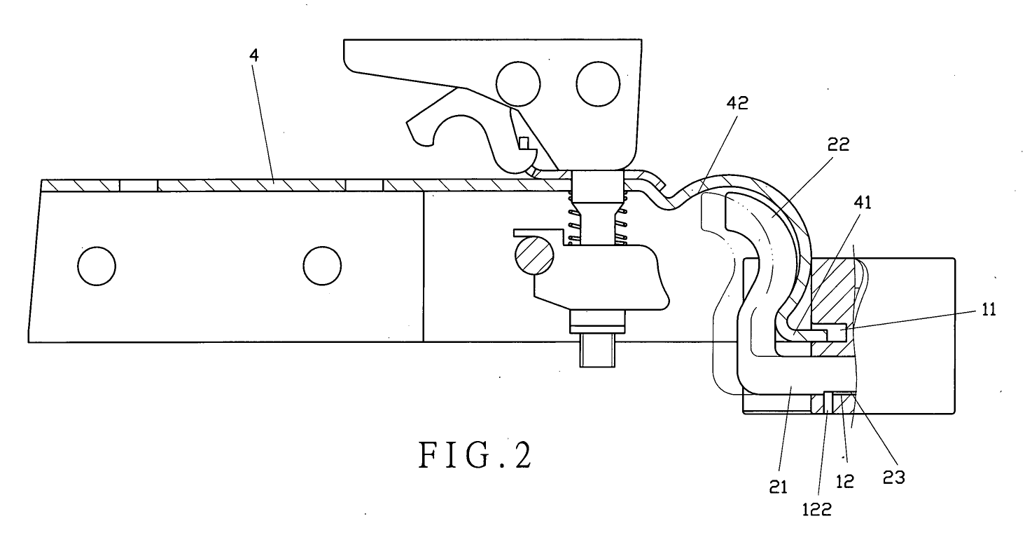

As shown in FIGS. 1 and 2, the present invention comprises a lock base 1, a hook 2 and a lock core 3. The lock base 1 has an outline corresponding to a connector 4. The lock base 1 comprises an engaging trough 11 corresponding in position to an edge 41 of the connector 4. A hole 12 is provided underneath the engaging trough 11. A pin hole 12 is provided at the bottom end of the hole 12 to receive a pin 22 therein. The pin 22 has a portion exposing outwardly from the pin hole 121. The lock core 3 is disposed in the lock base 1. The hole 12 is to receive a portion of the hook 2 therein, and the hook 2 is locked in place by the lock core 3 to control and restrict movement of the hook 2.

The hook 2 comprises a sliding section 21 and an engaging section 22. The sliding section 21 comprises at least one trough 211 at the top end to engage with the lock core 3 and a trough 23 at the bottom end for insertion of the pin 122 exposing outwardly from the pin hole 121 to restrict movement of the hook 2. The engaging section 22 comprises a curved section 221 corresponding in shape to a spherical recess 42 of the connector 4.

To practice the present invention, as shown in FIG. 2, the edge 41 of the connector 4 is inserted into the engaging trough 11 of the lock base 1. The engaging section 22 of the hook 2 is inserted into the spherical recess 42 and engages with the inner wall of the spherical recess 42. The sliding section 21 of the hook 2 is inserted into the hole 12 of the lock base 1. The lock core 3 controls movement of the sliding section 21 of the hook 2, which links the engaging section 22 to engage with the spherical recess 42.

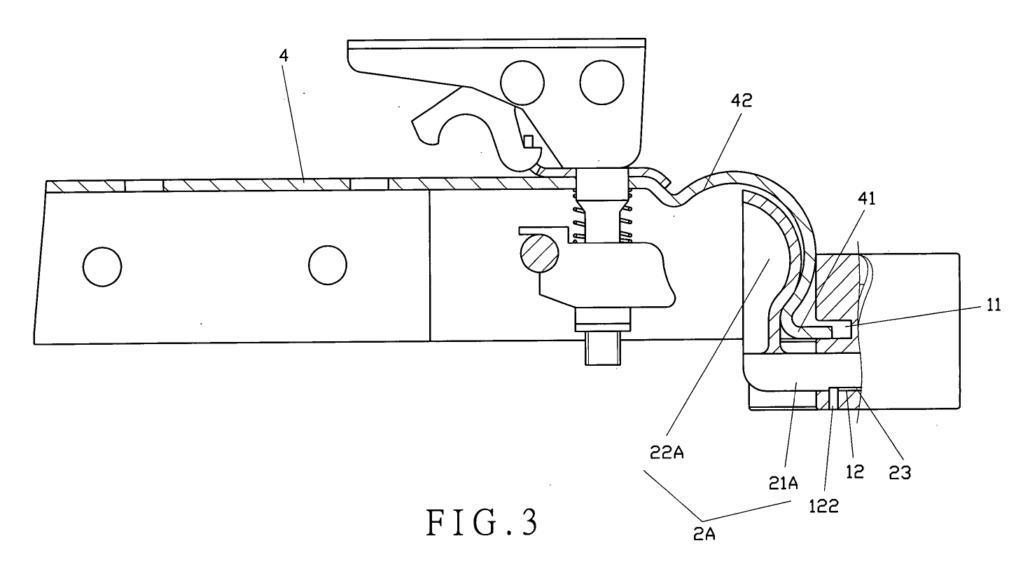

FIG. 3 shows a second embodiment of the present invention. A hook 2A has a semi-spherical engaging section 22A corresponding in shape to the spherical recess 42 to provide a larger engaging area.

I claim:

1. A safety device for a trailer connector comprising:
a lock base, said lock base comprising an engaging trough and a hole underneath said engaging trough;
a hook, said hook comprising a sliding section and an engaging section;
a lock core, said lock core being disposed in said lock base to control movement of said hook within said hole.

2. The safety device for a trailer connector, as recited in claim 1, wherein said sliding section of said hook comprises at least one trough to engage with said lock core.

3. The safety device for a trailer connector, as recited in claim 1, wherein said engaging section of said hook comprises a curved section.

4. The safety device for a trailer connector, as recited in claim 1, wherein said engaging section of said hook comprises a semi-spherical section.
